(19) United States
(12) Patent Application Publication
(10) Pub. No.: US 2015/0198307 A1
(43) Pub. Date: Jul. 16, 2015

(54) Mobile lighting system

(71) Applicant: Airbus Operations GmbH, Hamburg (DE)

(72) Inventor: Burkhard Brand, Hamburg (DE)

(21) Appl. No.: 14/670,043

(22) Filed: Mar. 26, 2015

Related U.S. Application Data
(63) Continuation of application No. PCT/EP2013/070263, filed on Sep. 27, 2013.
(60) Provisional application No. 61/706,143, filed on Sep. 27, 2012.

(30) Foreign Application Priority Data
Sep. 27, 2012 (DE) 102012019074.3

(51) Int. Cl. F21V 14/00; F21V 7/00; F21V 23/00; F21V 8/00

(52) U.S. Cl. CPC F21V 14/00; G02B 6/0096; F21V 7/0066; F21V 23/00; F21Y 2101/02

(57) ABSTRACT

A lighting device having a light source and a light tube made of a light-conducting material, to a lighting device having a light source and a rigid light radiating unit made of a light-conducting material, and to the use of the lighting devices for illuminating working positions e.g., on board a means of transport. The lighting device may comprise a light source and a light tube made of a light-conducting material. The light tube and the light source are couplable to one another in at least two different coupled states in such a manner that light emitted by the light source is coupled into the light tube. The light tube is configured to radiate the coupled-in light.

### CROSS-REFERENCES TO RELATED APPLICATIONS

This application is a continuation of International Application PCT/EP2013/070263 filed Sep. 27, 2013, designating the United States and published on Apr. 3, 2014 as WO 2014/049145. This application also claims the benefit of the U.S. Provisional Application No. 61/706,143, filed on Sep. 27, 2012, and of the German patent application No. 10 2012 019 074.3 filed on Sep. 27, 2012. The entire disclosures of the above are incorporated herein by way of reference.

### BACKGROUND OF THE INVENTION

The present invention relates to a lighting device having a light source and a light tube made of a light-conducting material, to a lighting device having a light source and a rigid light radiating unit made of a light-conducting material, and to the use of the lighting devices for illuminating working positions e.g., on board a means of transport.

To carry out a various tasks on different installations, machines, means of transport, such as e.g., on aircraft, trains, ships, trucks or buses, or other vehicles such as passenger cars, it is important for there to be good illumination, e.g., always appropriate for the work tasks, of the respective working positions. To visually follow assembly tasks or repair work, it is important for the responsible (assembly) personnel to illuminate the assembly or repair regions with sufficient light. Examples of assembly and inspection tasks which may be mentioned here are those during the installation of an aircraft cabin, e.g., final assembly tasks, or repair and inspection tasks on an engine of a truck or passenger car.

Often the luminous intensity or lighting range of conventional mobile lighting tools is not adequate in poorly accessible, poorly visible or inadequately illuminated working positions for assembly or inspection work during the production or disassembly, or repair or maintenance of machines or installations, and also for use in everyday situations. The light cones of flashlights, headlamps or other currently available lighting systems often do not reach as far as the object being worked on or the working position, owing to the mostly very restricted or obstructed working space, for example, when connecting and checking plug connections above or behind galley units in aircraft. To avoid blind assembly, however, a best-possible illumination of the assembly site is desired. Personnel responsible for the quality assurance also depend on adequate illumination while inspecting components and systems. An example which may be mentioned here is the reading of numbers arranged on the components and designating the corresponding components, such as numbers of manufacturer's parts drawings or of circuit cables, which sometimes cannot be read or cannot be read sufficiently well despite the use of hand mirrors.

### SUMMARY OF THE INVENTION

It is an object of the present invention to provide lighting devices and the use of the lighting devices for sufficient illumination of working positions.

According to a first aspect, a lighting device is provided. The lighting device comprises a light source and a light tube made of a light-conducting material.

The light tube and the light source are couplable to one another in at least two different coupled states in such a manner that light emitted by the light source is coupled into the light tube. The light tube is configured to radiate the coupled-in light.

The coupled states may also be called coupling states. The lighting device may take the form of a portable or mobile lighting device.

The light-conducting material may be any material which is suitable for transporting light over short or long distances, for example, in a range between 5 cm to 2 m or between 10 cm and 1 m, such as e.g., over 50 cm. The light tube may have as its shape any conceivable long-stretched-out or elongated shape. The light tube may be tubular, pipe-shaped or rod-shaped and have a round, e.g., elliptical or circular, cross-section. The light tube may, however, also have an angular, such as e.g., rectangular, square, v-shaped or triangular, cross-section or any other cross-sectional shape which is specifically developed for a range of applications envisaged. The controlled guidance of the light waves in the light tube may be achieved, for example, by reflection at the boundary of the light conductor either by total reflection owing to a lower refractive index of the medium surrounding the light conductor or by metalizing or mirror coating the boundary. The light waves may also be controlled or specifically guided by the above-mentioned cross-sectional shapes. Irrespective of the precise shape of the light tube or of the cross-section of the light tube, the light tube may be of flexible or bendable or shapeable form.

The light-conducting material may be, for example, a transparent, such as e.g., a fully transparent, material. It is conceivable for the light tube to be at least almost of fully transparent form. Examples of material which may be used are plastic, Plexiglas or other materials having light-conducting, e.g., transparent, properties. Furthermore, a flexible or bendable material may be used as the light-conducting material. For example, the light tube may take the form of a bendable light rod. The light rod may have as material e.g., a bendable plastic, such as polycarbonate. The light tube may be variably designed in its shape and/or its material, depending on the planned field of application.

For example, a different kind of light tube may be coupled to the light source, depending on the planned field of application. Thus, a set of different kinds of light tubes may be available, from which one may be selected and coupled to the light source, depending on the field of application. The different kinds of light tubes may differ e.g., in their shape, in their material and/or in their transparent and/or reflective properties.

The light source—as the place from which light emanates—may be any kind of artificial light source. The light source may take the form of an electrical light source, in order to convert electricity into light or generate light from electricity. Examples which may be mentioned here as possible electrical light sources are inter alia incandescent lamps, fluorescent lamps and light emitting diodes (LEDs). The light source may comprise one or more of the electrical light sources mentioned. The light source may be arranged at different places on or along the lighting device.

To supply the lighting device with electrical energy, e.g., for generating light from electricity, various power supply devices or power supply units may be used. For example, the lighting device may be connected to or equipped with an accumulator unit or a battery unit. Additionally or alternatively to this, the lighting device may be connected to a power supply network via a power cord. It is conceivable, for example, for the lighting device to be connectable or connected to a charging set for the accumulator unit, the charging set being connectable or connected to a power supply network.

The light tube and the light source are couplable to one another in at least two different coupled states. The at least two different coupled states may be convertible into one another.

In a first coupled state, the light tube and the light source are coupled to one another in such a manner that light emitted by the light source is coupled into a first end of the light tube. The coupled-in light is transported through the light tube in the longitudinal direction of the light tube. The light tube may be configured to radiate or emit at least part of the coupled-in light from a second end. The second end may be the end of the light tube opposite the first end. The second end of the light tube may be configured or shaped in such a manner that the emerging or radiated light is radiated in the form of a light cone, similar to the light cone of a flashlight. For example, the second end for radiating the light in the form of a light cone, similar to a flashlight, may be widened. A special shape of the second end is not necessary. The second end may, however, be configured or shaped in such a manner that the emerging light may be specifically focused or controlled. It is conceivable, for example, to provide a lens or a prism at the second end for this purpose.

In the first coupled state, the second end may also be called the free end.

The term “free” may be understood here to mean that the second end is not coupled to the light source, but radiates light coupled into the light tube.

If light is radiated from the second end, the second end may be connectable e.g., to a telescopic mirror unit and/or to a light magnifier. Instead of a light magnifier, a device for influencing the direction of the emerging light beam (direction-influencing device for short) may be used. Examples of direction influencing which may be mentioned here are the focusing by a lens or the deflection by an inclined mirror. The telescopic mirror unit may be arranged, for example, in such a manner relative to the second end of the light tube that the light emerging from the second end strikes the telescopic mirror unit and is deflected from the latter in the direction of the place to be illuminated or the region to be illuminated, for example, of the working position to be illuminated. The telescopic mirror unit may be detachably mounted e.g., on a fastening clamp, e.g., a metal clamp further described below. The light magnifier or the direction-influencing device may be arranged, for example, in such a manner relative to the second end of the light tube that the light emerging from the second end is focused by the light magnifier or is influenced in its direction by the direction-influencing device. The focused light or the direction-influenced light may then be deflected, for example, by a mirror arranged relative to the light magnifier or direction-influencing device, to the place to be illuminated or to the region to be illuminated, for example, the working position to be illuminated. The focused light may, for example, have a higher illuminance (incident light flux per area) than unfocused light. As a result, some, e.g., especially dark or confined, regions may be illuminated better and in a targeted manner.

In a second coupled state, the light tube and the light source may be coupled to one another in such a manner that light emitted by the light source is coupled into a first end and into a second end of the light tube. The first end may be the first end described in relation to the first coupled state, i.e., the end which is coupled to the light source also in the first coupled state for coupling-in light. The second end may be the end opposite the first end of the light tube. In the second coupled state, accordingly both the first end and the second end may be coupled to the light source in such a manner that light emitted by the light source is coupled both into the first end and into the second end, opposite the first end, of the light tube.

In the second coupled state, the light tube may be bent e.g., at least almost

U-shaped or omega-shaped. However, other shapes of the light tube in the second coupled state, such as e.g., a V-shape, are also conceivable.

Irrespective of the coupled state of light source and light tube, the light tube may be configured to radiate at least part of the coupled-in light via its outer circumferential surface, for example, in the case of a cylindrical or tubular light tube, its lateral surface. The radiation of light via the outer circumferential surface may be provided additionally or alternatively to the radiating of light from the second end.

At least one reflector element and/or screen element may be provided on the outer circumferential surface, for example, on the lateral surface, of the light tube. The reflector element may be incorporated in the light tube. The reflector element may be incorporated in the light tube e.g., by roughening the light tube in order to form the reflector element. As a result, the coupled-in light is unable or at least only negligibly able to emerge from the light tube at the roughened places, but is at least almost completely reflected there. The screen element may be deposited, such as e.g., stuck, on the outer circumferential surface of the light tube and be configured to prevent the light from emerging through the screen element. Additionally or alternatively to the reflector element and/or screen element, the emergence of the light may also be influenced or controlled via the shape of the cross-section of the light tube. For this purpose, the cross-section of the light tube may be e.g., v-shaped or triangular. Situated at the vertex of the “V” or the triangle may be different kinds of grooves, which scatter the light in a particular manner. The light tube may be formed for this purpose e.g., from a plastic, such as polyvinyl chloride (PVC).

The reflector element and/or screen element may be present at any places on the light tube, in order to obtain a desired radiating pattern of the light tube. This means the reflector element and/or screen element may be present in flexible patterns in or on the light tube. The reflector element and/or screen element may extend in the longitudinal direction, for example, along the entire longitudinal extent or in sections along the longitudinal extent, of the light tube. The reflector element and/or screen element may extend in the circumferential direction of the outer circumferential surface of the light tube. For example, the reflector element and/or screen element may extend in the circumferential direction along the entire outer circumference or only along a part of the outer circumference, it being possible for the part also to be subdivided into two or more sections. According to a specific configuration, it is conceivable for the reflector element and/or screen element to extend along the entire longitudinal extent of the light tube and along the entire outer circumferential surface of the light tube, so that in the first coupled state light emergence is only possible from the second end of the light tube. According to a second possible configuration, various variants are conceivable, in which the reflector element and/or screen element does not extend along the entire longitudinal extent of the light tube and along the entire outer circumferential surface of the light tube, but in each case only in punctual, strip-shaped or areal/planiform regions or sections, so that light emergence is possible only in the regions or sections which are not covered by the reflector element and/or screen element.

The lighting device may further comprise a housing. The light source may be accommodated in the housing. Additionally or alternatively to this, the light tube may be mountable on or in the housing for coupling to the light source. The material used for the housing may be e.g., aluminum. In order to prevent excessive heating of the housing, cooling ribs for removing waste heat may be arranged in or on the housing. By removing waste heat, it is possible e.g., to keep the temperature of the housing below a predetermined limit value, e.g., 40 degrees Celsius. The housing may have e.g., rounded corners at least almost without sharp edges. Furthermore, the housing may have a compact construction in order that it may be easily gripped also by a small human hand, such as e.g., a woman's hand. To the housing there may be fastened e.g., a loop, in order to be able to suspend the lighting device via this loop.

The light tube may be mounted on the housing in at least two different ways, in order correspondingly to bring about the at least two different coupled states.

Both for the coupling of the light source and the light tube according to the first coupled state and according to the second coupled state, the first end of the light tube may be mounted on or in the housing via a fixed connection. The light emitted by the light source may accordingly be coupled into the first end of the light tube, as described above. The fixed connection may be understood to mean that the connection cannot be detached by normal effort, but only if the otherwise fixed connection is deliberately detached e.g., for replacement of the light tube. The fixed connection may take the form e.g., of a screw connection or comprise a screw connection. For the fixed connection of the first end of the light tube to the housing, it is thus possible to use a screw connection or a connection comprising a screw connection.

For the coupling of the light source and the light tube according to the second coupled state, the second end of the light tube may, e.g., additionally, be mounted on or in the housing via a detachable connection. Accordingly, in the second coupled state, light emitted by the light source may be coupled into the second end of the light tube. According to the second coupled state, it is conceivable for both the first end and the second end of the light tube to be coupled to the housing, so that light emitted by the light source is coupled both into the first end and into the second end of the light tube.

The detachable connection may be understood to mean that the connection may be detached by normal effort. For the production of the detachable connection, a metal clamp may be arranged on the light tube and a magnet may be arranged on the housing. The magnetic force of the magnet may keep the metal clamp and thus the light tube in the second coupled state.

The light source may comprise two or more lighting elements, for example, two light emitting diodes, such as e.g., two power light emitting diodes. The two or more lighting elements may be arranged at different places on or along the lighting device. It is assumed below purely by way of example that the light source is formed from two light emitting diodes or light emitting diode groups. However, other light sources are also usable.

A first light emitting diode or light emitting diode group may be assigned to the first end of the light tube in such a manner that light emitted by the first light emitting diode or light emitting diode group may be or is coupled into the first end of the light tube. A second light emitting diode or light emitting diode group may be assigned to the second end of the light tube in such a manner that light emitted by the second light emitting diode or light emitting diode group may be or is coupled into the second end. Furthermore, provision may be made for further light emitting diodes or light emitting diode groups which may couple light into a further light tube or different kinds of light conductors (such as e.g., the light radiating unit described hereinbelow). Light emitting diodes of different colors may be used, e.g., cold-white or warm-white light emitting diodes.

In the first coupled state, the light tube and the light emitting diodes or light emitting diode groups may be coupled in such a manner that light emitted by the first light emitting diode or light emitting diode group is coupled into the first end of the light tube. In the second coupled state, the light tube and the light emitting diodes or light emitting diode groups may be coupled in such a manner that light emitted by the first light emitting diode or light emitting diode group is coupled into the first end of the light tube and light emitted by the second light emitting diode or light emitting diode group is coupled into the second end of the light tube.

Irrespective of the specific configuration of the light source, one or more mirrors or a mirror arrangement may be arranged between the light source, such as e.g., the light emitting diodes or light emitting diode groups, and the light tube in order to couple the light into the light tube. However, a coupling-in without mirrors is also conceivable. The light emitting diodes may be mounted, for example, as shock-resistantly as possible in or on the housing. It is also possible to arrange lenses/prisms between light source and light tube in order to focus the light emitted by the light source, e.g., the light emitting diodes or light emitting diode groups.

The light source, such as e.g., the two or more light emitting diodes, and/or the light tube may be formed e.g., in such a manner that with a light tube approx. 500 mm in length there is an intensity of 300 lux at the second end. With shorter or longer light tubes, e.g., approx. 700 mm in length, the light emission of the light source may be correspondingly adapted. The length of the light tube may be e.g., between 200 mm and 1000 mm, for example, between 400 mm and 800 mm, such as 500 mm or 700 mm. Furthermore, it is possible to provide a light source variable in its light emission (a dimmable light source).

The lighting device may further comprise a control unit for controlling the light source in dependence on the at least two different coupled states. The control unit may, for example, be configured to activate and/or to deactivate the light source in dependence on the at least two different coupled states. It is e.g., conceivable for the control unit to be configured to deactivate the light emitting diode or the light emitting diode group, the assigned end of which is not connected to the housing. For example, the lighting device may initially be in the second coupled state, in which both the first and the second end are coupled to the housing. In this case, both the light emitting diode or light emitting diode group assigned to the first end is activated and the light emitting diode or light emitting diode group assigned to the second end is activated. If subsequently the detachable connection between the second end and the housing is detached, this may be detected by the control unit. The control unit may thereupon deactivate the second light emitting diode or light emitting diode group. In this case, light is then coupled into the first end of the light tube only from the first light emitting diode or light emitting diode group.

Irrespective of the precise configuration of the lighting device, the lighting device may be divisible or separable into two or more parts. At least one of these parts may, in turn, itself take the form of or serve as a lighting device, as described herein. Such parts may also be called functional parts of the lighting device. For example, the at least one (functional) part may comprise at least one light source, a control unit and/or a power supply device, as described herein. At least one of the further parts may be non-functional, e.g., in that although one or more light sources are present, there is no control unit and/or power supply device. It is likewise conceivable for all separated-off parts to serve, as partial lighting devices per se, in turn, as a lighting device. It is conceivable for one or more separated-off parts to be non-functional and one or more separated-off parts to be functional. The divisibility of the lighting device may enable especially poorly accessible places to be reached and illuminated. For example, firstly a certain area may be illuminated with the aid of the lighting device. A poorly accessible, e.g., particularly confined, place may be illuminated, for example, by dividing the lighting device and using one of the functional parts of the lighting device for illuminating the poorly accessible place. The connection between the separable parts may be achieved in various ways. Purely by way of example, mention may be made here of a magnetic connection, a connection via quick acting screws or a connection with the aid of a rail fixing system. Further flexibility may be achieved, as described above, by the modular use of different light tubes.

According to a second aspect, a further lighting device is provided. The lighting device comprises a light source and a rigid light radiating unit made of a light-conducting material. The light radiating unit and the light source are couplable to one another in such a manner that light emitted by the light source is coupled into the light radiating unit. The light radiating unit is configured to radiate the coupled-in light.

The lighting device according to the second aspect differs from the lighting device according to the first aspect in that a rigid light radiating unit is present instead of a light tube. With regard to all other possible details and optional configurations, reference is made to the details and configurations described in relation to the lighting device according to the first aspect, which may be realized in a similar or the same way also in the lighting device according to the second aspect.

For the light radiating unit present in the lighting device according to the second aspect, no flexible or bendable material is used. Instead, the light radiating unit is of rigid, hard or firm form. Here, the terms rigid, hard or firm may be understood to mean that the light radiating unit cannot be bent in normal use, but e.g., only when excessive force is applied.

The light radiating unit and the light source may be in at least two different coupling states relative to one another. The at least two different coupling states may be convertible into one another.

In a first coupling state, the light radiating unit may be coupled to the light source in such a manner that light emitted by the light source is coupled into the light radiating unit. In the case where the light source comprises e.g., two light emitting diodes or two light emitting diode groups, in the first coupling state the light radiating unit may be coupled to all, e.g., both, light emitting diodes or light emitting diode groups.

In a second coupling state, the light radiating unit may be coupled only to part of the light source. In the case where the light source comprises e.g., two light emitting diodes or two light emitting diode groups, in the second coupling state the light radiating unit may be coupled only to part, e.g., one, of the two light emitting diodes or light emitting diode groups.

In a third coupling state, the light radiating unit may be uncoupled from the light source. In the case where the light source comprises e.g., two light emitting diodes or two light emitting diode groups, in the third coupling state the light radiating unit may be coupled to neither of the two light emitting diodes or light emitting diode groups.

The rigid light radiating unit may have various geometrical shapes and be formed from various firm materials, such as firm glass or firm Plexiglas, depending on the application. For example, the light radiating unit may be formed in the shape of a plate or disc made of light-conducting material. Furthermore, the light radiating unit may be parallelepipedal, rod-shaped, cuboid, pyramidal or frustopyramidal, conical or frustoconical, paraboloidal, prism-shaped or spherical or formed from a combination of these or further geometrical shapes. For the light radiating unit, e.g., any three-dimensional shape, such as an oval shape, a rectangular shape, a circular shape or combinations thereof, is conceivable. The lighting device according to the second aspect may be used modularly with different kinds of light radiating units, as described in relation to the lighting device according to the first aspect in combination with different kinds of light tubes. For example, a set of different kinds of light radiating units may be available, one or a plurality of different ones of which may be coupled to the light source(s), depending on the field of application.

The lighting device according to the second aspect may be separable or divisible in the same way as the lighting device according to the first aspect. Accordingly, regarding the possible realizations of the divisibility, reference is made to the lighting device according to the first aspect. In the case of a rod-shaped light radiating unit, e.g., made of Plexiglas, for example, at least one functional part may be separated off, e.g., the part having a light source and additionally a control unit and/or a power supply device. The separated-off at least one (functional) part may thus be used to illuminate poorly accessible places. The one or more remaining parts may be functional or, taken by itself or themselves, non-functional.

According to a third aspect, the use of the light source, as described herein, is provided for illuminating working positions, e.g., on board a means of transport, for example, on board an aircraft, or working positions of installations or machines The working positions may be e.g., places at which particular tasks, such as assembly or installation, are to be performed, or at which particular information is to be discerned or read.

### BRIEF DESCRIPTION OF THE DRAWINGS

Specific embodiments of the present invention are explained below with reference to the appended schematic figures, in which:

FIG. 1 shows a schematic representation of a first possible embodiment of the lighting device;

FIG. 2 shows a schematic representation of a second possible embodiment of the lighting device;

FIG. 3a shows a schematic representation of a variant of the second possible embodiment of the lighting device;

FIG. 3b shows a schematic representation of a combination of the first and the second possible embodiment of the lighting device; and

FIG. 4 shows a schematic representation of a divisible variant of the lighting devices from FIGS. 1 and 2.

### DETAILED DESCRIPTION OF THE PREFERRED EMBODIMENTS

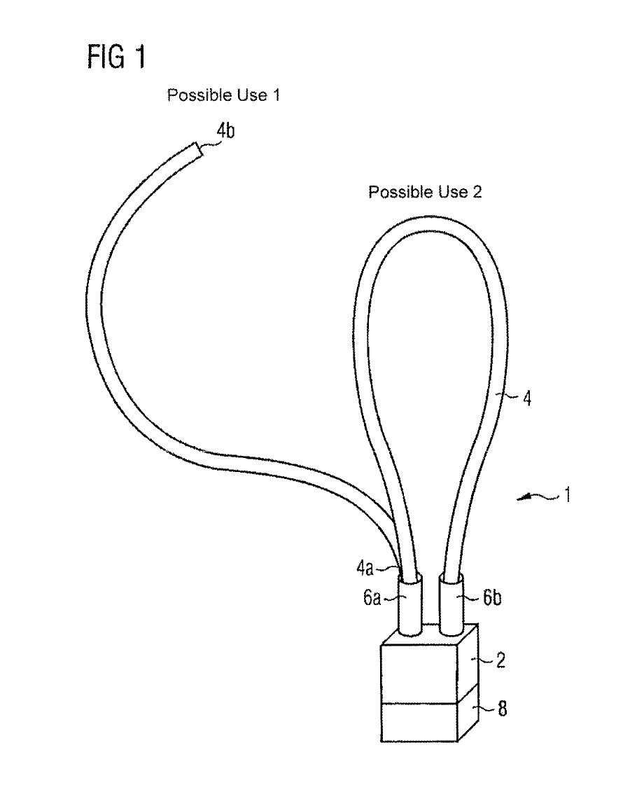

FIG. 1 shows a lighting device 1 according to a first possible embodiment. The lighting device 1 comprises a housing 2, in which a control unit (not shown) is arranged. Two light emitting diodes (LEDs) 6a, 6b as light sources or as a light generating unit are accommodated in the housing 2. Alternatively, as shown in FIG. 1, the two LEDs 6a, 6b are connected to the housing 2 or are part of the housing 2 (in this respect, reference is made below alternately to a connection between light tube and housing or light tube and LEDs). Furthermore, as power supply unit, an accumulator 8 for supplying the lighting device 1 with electrical energy is arranged on the housing 2. With the aid of the electrical energy provided by the accumulator 8, the LEDs 6a, 6b can generate light. Furthermore, the accumulator 8 serves for supplying the control unit with electrical energy.

In FIG. 1, two different coupled states for the light tube 4 are shown. In the exemplary embodiment from FIG. 1, the light tube 4 is formed from a flexible material and is thus shapeable, e.g., bendable. As a result, the light tube can be simply converted from one coupled state into another coupled state. According to the first coupled state, which can also be called a coupling state (called possible use 1 in the figure), a first end 4a of the light tube 4 is connected to a first 6a of the LEDs. Furthermore, the second end 4b of the light tube 4 is not connected to the housing 2 or one of the LEDs 6a, 6b, but is free. In the first coupling state, the control unit detects that only the first end 4a and not the second end 4b of the light tube 4 is connected to the housing 2. Accordingly, only the LED 6a, but not the LED 6b is activated by the control unit. The light emitted by the LED 6a is coupled into the first end 4a of the light tube and transported through the light tube 4. In the process, the light tube 4 radiates light along its lateral surface. Furthermore, the second end 4b of the light tube 4 radiates light in the form of a light cone. With the aid of the first coupling state, regions which are difficult to access or reach can also be illuminated. For example, with the aid of the lighting device in the first coupling state, it is also possible to illuminate even many assembly and inspection regions which are obstructed or difficult to access, and which cannot be illuminated at all or only with difficulty using conventional lighting tools radiating only simple light cones, such as flashlights or headlamps.

In the second coupled state, which can also be called the second coupling state (called possible use 2 in the figure), additionally the second end 4b of the light tube 4 is connected to the housing 2, to be more precise to the second LED 6b. In the second coupling state from FIG. 1, the light tube 4 has at least approximately an omega shape, although other specific shapes are also conceivable. The control unit detects that the second end 4b of the light tube 4 is connected to the second LED 6b. Thereupon, the control unit activates the LED 6b. The light emitted by the LED 6b is coupled into the second end 4b. Additionally, the light emitted by the first LED 6a is still coupled into the first end of the light tube 4. The light coupled into the light tube 4 from both sides is transported through the light tube 4 and emitted to the surroundings via the lateral surface of the light tube 4. In this state, a strong light intensity and thus good illumination can be achieved.

Additionally, a reflector element can be integrated in the light tube 4 (not shown) or a screen element can be stuck onto the light tube 4 (not shown). The reflector element and/or screen element can be present at any places on the light tube, in order to obtain a desired radiating pattern of the light tube. Even though the light tube shown in FIG. 1 is of cylindrical shape, any other shapes are conceivable. For example, with the aid of a special form or shape of the light tube or of the cross-section of the light tube, the specific radiation of the light can also be influenced. It is thus conceivable that, additionally or alternatively to the reflector element and/or screen element, the emergence of the light is influenced or controlled via the shape of the cross-section of the light tube. For this purpose, the cross-section of the light tube can, for example, be v-shaped or triangular. Situated at the vertex of the “V” or the triangle can be different kinds of grooves, which scatter the light in a particular manner.

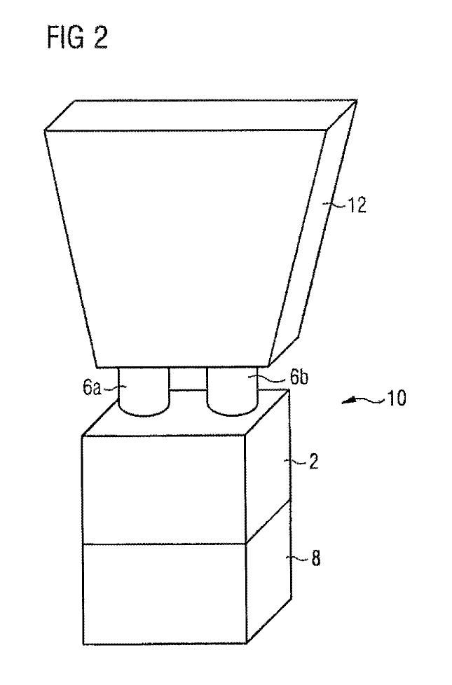

FIG. 2 shows a lighting device 10 according to a second possible embodiment. In FIG. 2, the components and units corresponding to the first embodiment from FIG. 1 are provided with the same reference symbols. The lighting device 10 comprises a housing 2, in which a control unit (not shown) is arranged. Two light emitting diodes (LEDs) 6a, 6b as light sources or as a light generating unit are accommodated in the housing 2. Alternatively, as shown in FIG. 1, the two LEDs 6a, 6b are connected to the housing 2 or are part of the housing. Furthermore, as power supply unit, an accumulator 8 for supplying the lighting device 10 with electrical energy is arranged on the housing 2. With the aid of the electrical energy provided by the accumulator 8, the LEDs 6a, 6b can generate light. Furthermore, the accumulator 8 serves for supplying the control unit with electrical energy.

Furthermore, the lighting device 10 comprises a rigid light radiating unit 12 made of a light-conducting, firm material. In a first coupling state illustrated in FIG. 2, the light radiating unit 12 is coupled to the two LEDs 6a, 6b in such a manner that light emitted by the two LEDs 6a, 6b is coupled into the light radiating unit. Purely by way of example as a possible shape in FIG. 2, the light radiating unit 12 is frustopyramidal (a pyramid with a rectangular base serves as the starting shape here). This shape is, however, to be understood as being purely by way of example, i.e., the light radiating unit 12 may have other geometrical shapes. The coupled-in light can be radiated by the light radiating unit 12, e.g., by the (outer) surfaces forming the light radiating unit 12. As described in relation to the first embodiment from FIG. 1, a reflector element and/or screen element for forming different desired radiating patterns can be flexibly present on the light radiating unit 12.

In a second coupling state (not shown), the light radiating unit 12 can, for example, be coupled to only one or neither of the two LEDs 6a, 6b.

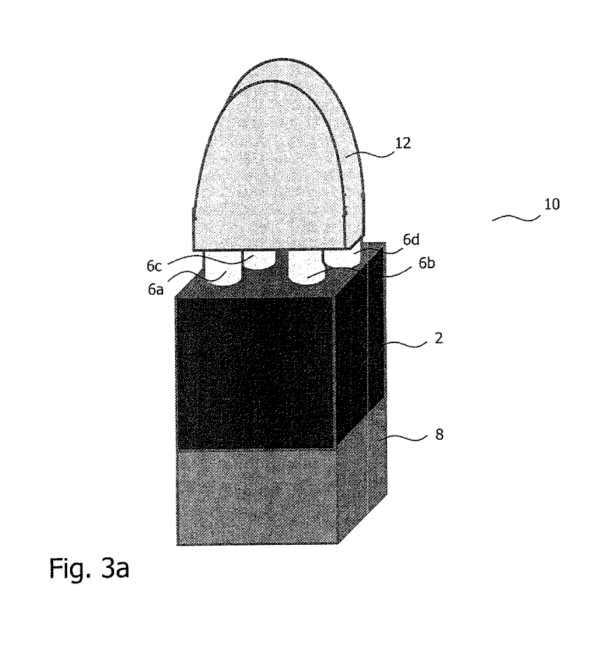

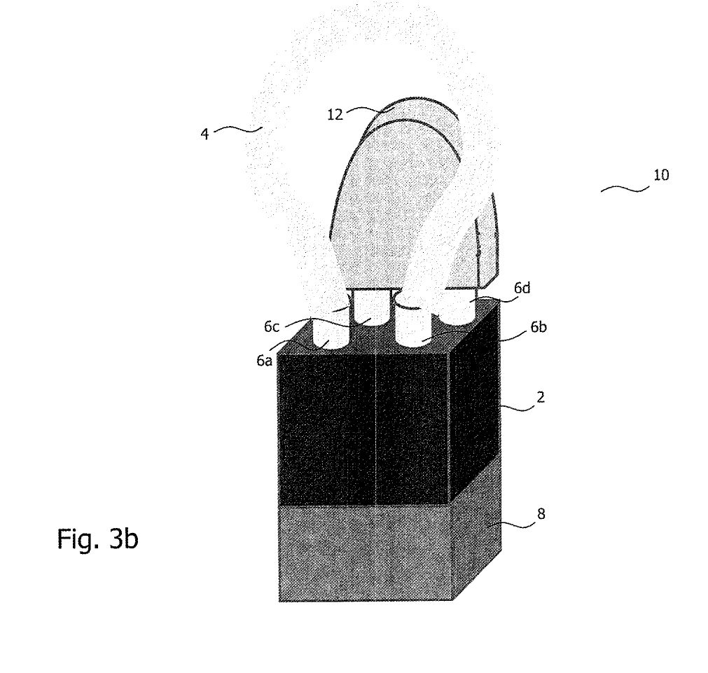

FIG. 3a shows a variant of the lighting device 10 from FIG. 2. The lighting device 10 according to this variant has, by way of example, four LEDs 6a to 6d in order to illustrate that the lighting device 10 can also comprise more than two LEDs. The four LEDs 6a to 6d serve to extend the operative range in that more lumens are available, e.g., for illuminating larger spaces (e.g., an empty aircraft fuselage), if no external power supply point is available.

It is likewise conceivable for the lighting device 1 from FIG. 1 to have more than two LEDs 6a, 6b, such as for example, four LEDs. In this case, two light tubes 4 could be provided, these being correspondingly respectively couplable to two of the four LEDs. Furthermore, in FIG. 3a, a further possible shape of the light radiating unit 12 is illustrated purely by way of example. This shape has a rectangular base with a paraboloidal lateral surface.

In FIG. 3b, a combination of the lighting device 1 according to the first possible embodiment and the lighting device 10 according to the second possible embodiment is schematically represented. For the sake of simplicity, this combination is designated as the lighting device 10. As can be seen in FIG. 3b, the lighting device 10 comprises both a light tube 4 and a light radiating unit 12. Purely by way of example, the light radiating unit 12 has the same shape as the light radiating unit 12 from FIG. 3a. The light radiating unit may, however, have any other geometrical shapes. The light tube 4 is connected by one end to the LED 6a and by the other end to the LED 6b. The light radiating unit is connected to two LEDs 6c, 6d. An illumination can take place, selectively, with only the light tube 4, with only the light radiating unit 12 or with both (the light tube 4 and the light radiating unit 12). If one of the ends of the light tube is detached from one of the LEDs 6a, 6b, this end can be used as a now free end for illuminating poorly accessible places. The combination of light tube 4 and light radiating unit 12 in a lighting device 10 allows high flexibility in the illumination.

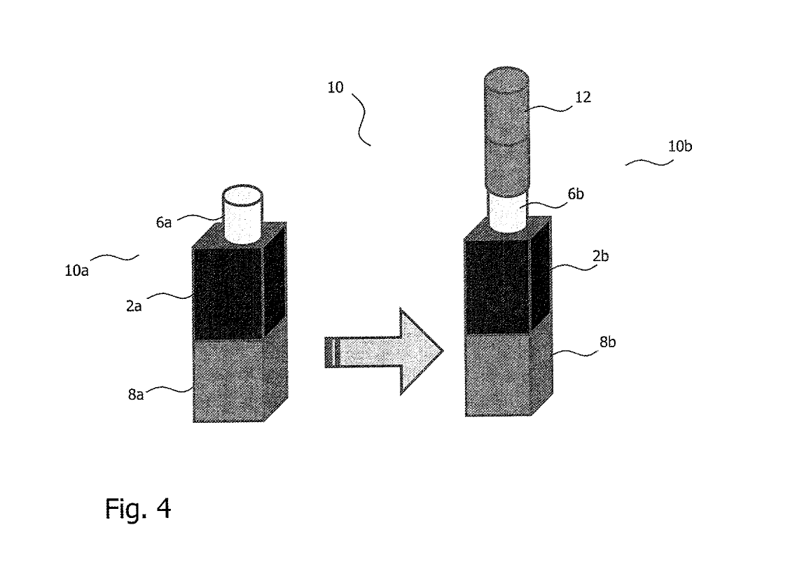

In FIG. 4, a divisible variant of the lighting device 10 from FIG. 2 is represented. The divisible variant is, however, also applicable in a corresponding manner in relation to the lighting device 1 from FIG. 1. As can be seen in FIG. 4, purely by way of example the lighting device 10 can be separated into two at least approximately equal-size parts. Purely by way of example, it is assumed in the following that the left part 10a is non-functional, i.e., cannot radiate light. This may be due, for example, to the fact that the left part 10a has no control unit functioning independently of the right part 10b and/or no working accumulator 8a. Alternatively, however, it is also conceivable for the left part 10a to be functional, i.e., able to generate and radiate light. The separation and joining together of the two parts 10a, 10b can take place, for example, by providing magnetic elements on the surfaces to be joined together.

The right part 10b has the right LED 6b, the right part of the housing 2b and the right part of the accumulator 8b. A functioning control unit can be provided in the right part of the housing 2b, e.g., the control unit responsible for the entire lighting device 10. The right LED 6b, the control unit and the right part of the accumulator 8b can function independently of the left part 10a. One end of the light radiating unit 12 is connected to the right LED 6b. Owing to the separation of the two parts 10a, 10b, the right part 10b is significantly handier than the entire lighting device 10 and can thereby also be guided into confined places which are not reachable by means of the lighting device 10, e.g., into openings through which the lighting device 10 does not fit.

In the case of a bendable light tube 4, for the separation of the two parts 10a, 10b, one end of the light tube 4 can be detached from the left LED 6a and used as the radiating end. The other end of the light tube 4 then remains connected to the right LED 6b.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A lighting device comprising:
a light source; and
a light tube made of a light-conducting material;
wherein the light tube and the light source are couplable to one another in at least two different coupled states in such a manner that light emitted by the light source is coupled into the light tube, and the light tube is configured to radiate the coupled-in light.

2. The lighting device according to claim 1, wherein the light tube and the light source are coupled to one another in a first coupled state in such a manner that light emitted by the light source is coupled into a first end of the light tube.

3. The lighting device according to claim 2, wherein the light tube is configured to radiate at least part of the coupled-in light from a second end.

4. The lighting device according to claim 3, wherein the second end is couplable to a telescopic mirror unit.

5. The lighting device according to claim 1, wherein the light tube and the light source are coupled to one another in a second coupled state in such a manner that light emitted by the light source is coupled into a first end and into a second end of the light tube.

6. The lighting device according to claim 1, wherein the light tube is configured to radiate at least part of the coupled-in light via its outer circumferential surface.

7. The lighting device according to claim 1, wherein at least one reflector element or screen element is provided on the outer circumferential surface of the light tube.

8. The lighting device according to claim 1, wherein the lighting device further comprises a housing, in which the light source is accommodated or on which the light tube is mountable, in order to couple the light source and the light tube.

9. The lighting device according to claim 8, wherein, for the coupling of the light source and the light tube according to at least one of the first and the second coupled state, a first end of the light tube is mounted on the housing via a fixed connection.

10. The lighting device according to claim 8, wherein, for the coupling of the light source and the light tube according to the second coupled state, a second end of the light tube is mountable on the housing via a detachable connection.

11. The lighting device according to claim 10, wherein, for the production of the detachable connection, a metal clamp is arranged on the light tube and a magnet is arranged on the housing.

12. The lighting device according to claim 1, wherein the light source comprises two or more lighting elements.

13. The lighting device according to claim 1, wherein the light source comprises two light emitting diodes.

14. The lighting device according to claim 1, wherein the lighting device further comprises a control unit for controlling the light source in dependence on the at least two different coupling states, wherein the control unit is configured to activate or to deactivate the light source in dependence on the at least two different coupling states.

15. The lighting device comprising:
a light source; and
a rigid light radiating unit made of a light-conducting material;
wherein the light radiating unit and the light source are couplable to one another in such a manner that light emitted by the light source is coupled into the light radiating unit, and the light radiating unit is configured to radiate the coupled-in light.
